(19) United States
(12) Patent Application Publication
(10) Pub. No.: US 2006/0096428 A1
(43) Pub. Date: May 11, 2006

(54) Riving knife assembly

(76) Inventors: Jaime E. Garcia, Jackson, TN (US); Craig A. Carroll, Milan, TN (US); Kathy DeKeyser, Jackson, TN (US); Mat Ros, Jackson, TN (US); Jeffrey D. Weston, Jackson, TN (US)

Correspondence Address: THE BLACK & DECKER CORPORATION, 701 EAST JOPPA ROAD, TW199, TOWSON, MD, 21286, US

(21) Appl. No.: 10/801,066

(22) Filed: Mar. 15, 2004

Related U.S. Application Data
(60) Provisional application No. 60/455,074, filed on Mar. 14, 2003.

(51) Int. Cl. B23D 45/06

(52) U.S. Cl. 83/102.1; 83/477.2

(57) ABSTRACT

The present invention provides a riving knife assembly for use with a saw assembly, such as a table saw. The riving knife assembly is enabled with a riving knife blade having a first end for extending above a planar work surface established by the saw assembly and a second end for connecting the riving knife with the saw assembly. The second end of the riving knife blade includes a riving engagement mechanism which enables the riving knife blade to connect with a saw coupling mechanism in a manner which may promote the riving knife blade to be more quickly and easily inserted into and/or removed from an operational stance with the saw assembly.

### CROSS REFERENCE TO RELATED APPLICATION

The present invention claims priority under 35 U.S.C. §119(e) to the U.S. Provisional Application Ser. No. 60/455,074, filed on Mar. 14, 2003, which is herein incorporated by reference in its entirety.

### FIELD OF THE INVENTION

The present invention relates generally to riving knives, and more specifically to riving knife assemblies for use with a saw assembly, such as a table saw, a circular saw, a band saw, a hand saw, and the like.

### BACKGROUND OF THE INVENTION

Riving knives are used with a variety of saw assemblies and serve a number of purposes. One purpose a riving knife may serve is to stabilize a work piece as it is being cut, the knife being engaged in the slot, groove, notch, and the like (kerf) created by a saw blade as the work piece is fed in the cutting direction. Another purpose a riving knife may serve is to keep the kerf open as the work piece is fed into or across the saw blade. This action may prevent binding of the work piece and reduce wear on the saw blade. Yet another purpose a riving knife may serve is to increase the safety of the saw device for a user during operation. If the riving knife is located behind the saw blade in such a manner as to limit possible contact with the blade, the user is less likely to accidentally contact the saw blade.

Frequently, it is desirable to change the height, orientation, geometry, and the like of a riving knife. For instance, a user may switch from making a through cut in a work piece to making a dado cut, requiring a riving knife with a much lower profile. Alternately, a user may switch from making a dado cut to making a through cut, and wish to replace the low profile riving knife with a riving knife including an integrated blade guard, anti-kickback pawls, and the like. It may also be desirable to change a riving knife to one providing a greater or lesser thickness, depending on blade width. However, in many typical applications a riving knife may be attached to a table saw in such a way as to make changing the riving knife difficult. Additional hardware may be required to change the riving knife, or the riving knife may be an integral part of the table saw.

It is typical for many saw devices to employ quadrilateral linkage assemblies to provide adjustment of riving knife height. These linkage assemblies tie the height of the riving knife directly to the saw blade height. This limited application severely limits the variety of cuts capable of being performed by the saw device and may force operators of saw devices to have to remove the riving knife when it is incapable of providing the needed orientation. This results in decreased production and increased costs as operators are forced to spend valuable time removing and installing the riving knife for separate cuts.

In many typical applications a screwdriver, wrench, or some other suitable device may be needed to change the riving knife of a table saw. But in many instances, the conventional use of a screwdriver, wrench, or other suitable device to tighten or loosen the fasteners securing a riving knife may not be desirable. The riving knife may be recessed within a casing or surrounded by an additional assembly, making it difficult if not impossible to access the fasteners securing the riving knife with a screwdriver, wrench, or other suitable device of sufficient size to provide adequate mechanical advantage.

Another problem arises when a riving knife must be secured or removed at a remote location. The absence of a screwdriver, wrench, or other suitable device may effectively prevent the removal or replacement of the riving knife. Further, securing or removing a riving knife with a screwdriver, wrench, or some other suitable device may be dangerous. Because of the nature of the mechanical advantage provided by the screwdriver, wrench, or other suitable device, a handhold is typically used for stability as force is imparted to tighten or loosen a fastener. The most effective location for such a handhold is in the plane of the fastener, which typically corresponds to the plane of the saw blade; thus, a poorly chosen handhold could prove disastrous. A table saw may have a large area of exposed blade, and care must be taken to engage the blade guard before grasping any area near the blade to tighten or loosen a riving knife.

Often operators of saw devices may want to use a riving knife during one operation but not another. Unfortunately, with the typical riving knife assembly employed today, operators are forced to expend time and labor making the required removals and installations as mentioned above. This results in increased production costs and decreased productivity. Further, the difficulty of installing and removing these riving knifes may result in harm to the operator and the machinery.

Typically the riving knife assemblies are directly coupled to the saw very near the blade. While some riving knife assemblies have moved very small distances away from the blade they still present a risk to the operator in that to interact with the riving knife the operator's body parts are often within the area of operation of the saw blade.

Commonly employed safety devices include blade guards which may be attached to the riving knife. Unfortunately, these blade guards are often very large and cumbersome to work with. Further, they may serve to impede an operator's view of the work area of the saw blade. It would be advantageous to provide a blade guard with a thinner profile, making it easier for the operator to use and maintaining a larger field of view of the work piece in a work area of the blade.

Another frequently encountered problem when using saw devices to operate upon a work piece is “kick up”. Kick up is a term used to describe an action of a board while being cut. Kick up results in the board moving out of the plane of a work area which can lead to damage to the rest of the work piece as it is being fed through the saw blade and even harm to the operator. It is commonplace for saw devices to employ separate machinery, such as rollers, to prevent “kick up”; however, this machinery typically requires a significant investment of money for acquisition and may tally significant maintenance costs for operation.

Consequently, it would be desirable to provide a riving knife assembly enabled to be secured and released from a saw device without requiring the use of tools or placing an operator in danger of harm from the saw blade. Further, a riving knife assembly which is independently adjustable relative to a saw blade and capable of being selectively used would be desirable. Additionally, it would be desirable to provide a riving knife assembly capable of affording protection to the operator from the saw blade and from aberrant movement of the work piece being operated upon by the saw. Still further, a riving knife assembly which was capable of assisting in stabilizing a work piece upon the table saw would be desirable to avoid damage to the work piece and harm to the operator.

### SUMMARY OF THE INVENTION

Accordingly, it is an object of the present invention to provide a riving knife assembly enabled with a quick change capability. The quick change capability promoting a more efficient riving knife capability. For instance, a user of the quick change riving knife may be enabled to reduce the time spent establishing a riving knife blade upon a saw assembly, thereby, promoting an increase in saw assembly up time which may further promote an increase in production by the saw assembly. Another object of the quick change riving knife may be assisting in promoting an easier to implement riving knife which may further promote an increase in the safety of operation of the saw assembly.

It is a further object of the present invention to provide an adjustment assembly which may enable a user to selectively determine the position of a riving knife blade with respect to the saw assembly. It is generally accepted that the riving knife blade is established in a position behind the saw blade or opposite the side of the saw blade which establishes a cutting interface with a work piece. However, the present invention enables the user to adjust the vertical orientation and horizontal orientation of the riving knife blade with respect to the position behind the saw blade. Adjustment of the horizontal orientation enables the user may move the riving knife blade closer to or further away from the saw blade. The vertical adjustment capability enables the movement of the riving knife blade up or down relative to the saw blade. It is understood that the movement of the riving knife blade correlates to a change in the position of the riving knife blade relative to a work surface of the saw assembly.

It is a still further object of the present invention to provide a biasing assembly which operates upon a riving knife of a saw assembly. The biasing assembly for enabling the maintenance of the riving knife in the kerf of a work piece being cut by a saw blade of the saw assembly. The biasing assembly may be enabled to provide a constant force. Alternatively, the biasing assembly may be enabled with a user selectable capability which allows the user to determine the position of the riving knife provided by the biasing assembly.

The present invention further contemplates the riving knife of the present invention may be variously configured to include a variety of additional features. Such features including a blade guard which may be integral with the riving knife. In alternative embodiments, the blade guard may be coupled in a manner which allows the removal of the blade guard from the riving knife. Additionally, the riving knife may be configured with a spring tab mechanism or a wedge flange. These features may provide assistance in preventing the “kick-up” of a work piece as it is being cut by the saw blade. Another feature may include establishing the riving knife as a friction riving knife. The friction riving knife providing the blade with a further alternative method of assisting in the prevention of “kick-up” of a work piece.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an illustration of a first exemplary embodiment of a quick change riving knife assembly engaging a plurality of pins in accordance with the present invention;

FIG. 2A is an illustration of a second exemplary embodiment of a quick change riving knife assembly engaging a plurality of studs in accordance with an exemplary embodiment of the present invention;

FIG. 2B is a side view illustration of the second exemplary embodiment of the quick change riving knife assembly engaging a plurality of studs;

FIG. 3 is an illustration of a table saw assembly including the first exemplary embodiment of the quick change riving knife assembly engaging a plurality of pins, as shown in FIG. 1;

FIG. 4 is an illustration of a riving knife adjustment assembly coupled with a table saw assembly in accordance with an exemplary embodiment of the present invention;

FIG. 5 is an illustration of a first exemplary biasing riving knife assembly including a compression spring assembly coupled with a riving knife;

FIG. 6 is an illustration of a second exemplary biasing riving knife assembly including a rotation spring assembly coupled with a riving knife;

FIG. 7 is an illustration of a third exemplary biasing riving knife assembly enabled as a pop-up riving knife assembly in accordance with the present invention;

FIG. 8 is an illustration of a fourth exemplary biasing riving knife assembly enabled as a position riving knife assembly;

FIG. 9 is an illustration of a blade guard for a riving knife assembly in accordance with an exemplary embodiment of the present invention;

FIG. 10 is an illustration of a spring tab mechanism for a riving knife assembly in accordance with an exemplary embodiment of the present invention;

FIG. 11 is a side view illustrating the riving knife spring tab mechanism engaged with a work piece;

FIG. 12 is an illustration of a wedge flange for a riving knife assembly in accordance with an exemplary embodiment of the present invention;

FIG. 13 is a side view illustrating the wedge flange of the riving knife assembly engaged with a work piece;

FIG. 14 is an illustration of a profile riving knife assembly in accordance with an exemplary embodiment of the present invention; and

FIG. 15 is an illustration of a friction riving knife assembly established with a high/low friction mechanism in accordance with an exemplary embodiment of the present invention.

### DETAILED DESCRIPTION OF THE INVENTION

Reference will now be made in detail to the presently preferred embodiments of the invention, examples of which are illustrated in the accompanying drawings.

Referring generally now to FIGS. 1 through 15, exemplary embodiments of the present invention are shown. It is understood that riving knife assemblies are typically employed with saw assemblies, such as table saws. Many of these table saw assemblies include arbor assemblies which operationally couple a motor with a circular saw blade 302, the motor imparting an angular momentum to the circular saw blade 302 for the performance of a cutting functionality by the circular saw blade 302 upon a work piece. A plurality of teeth of the circular saw blade 302 engage with the work piece establishing a cutting interface at a first “leading” edge of the circular saw blade 302. The cutting interface of the saw blade 302 establishes a kerf in the work piece, that kerf enabling the work piece to continue past the sides of the saw blade 302.

The rotation of the circular saw blade 302 further establishes a second “trailing” edge, which is the position the teeth of the saw blade 302 assume when established at the farthest point from the cutting interface. Generally, the riving knife blade 102 of a riving knife assembly is established in a position relative to the second “trailing” edge of the saw blade 302. In other words, the riving knife blade 102 is generally established behind the saw blade 302 in operation of the table saw. Further, the riving knife blade 102 typically has a width which is less than or equal to the kerf established by the saw blade 302. The location and width of typical riving knife blades 102 enable the riving knife blades 102 to engage with the work piece after it has passed the saw blade 302 by inserting into the kerf established in the work piece.

FIG. 1 is directed to a first exemplary embodiment of a quick change riving knife assembly 100 for a table saw assembly that is capable of engaging and releasing a riving knife to and from the table saw assembly. The current embodiment, establishes the quick change riving knife assembly 100 including a riving knife blade 102 having a first end 104 and a second end 106. The first end 104 of the riving knife blade 102 is substantially that portion of the blade which extends above a work surface of the table saw assembly. The second end 106 of the riving knife blade 102 includes a riving knife engagement mechanism 108. In a preferred embodiment, the riving knife engagement mechanism 108 is enabled as a first receiver 110 and a second receiver 112. In the current embodiment, the riving knife engagement mechanism 108 includes a first pin slot 110 and a second pin slot 112 for engaging with pins 114. It is understood that the number, location, and configuration of the first and second receivers 110 and 112 of the riving knife engagement mechanism 108 may vary as contemplated by one of ordinary skill in the art. This engagement provides stability and support to the quick change riving knife assembly 100 when engaged with the table saw assembly.

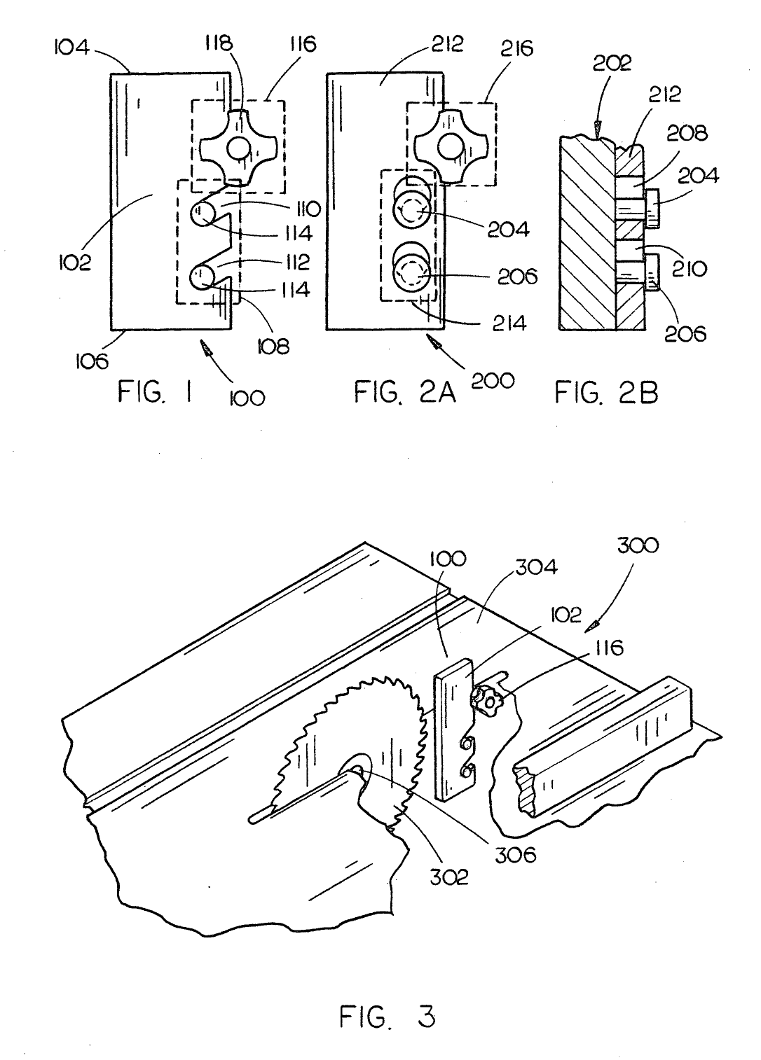

The riving knife engagement mechanism 108 may be variously configured to accommodate its connection with a riving knife receiving mechanism 202 (shown in FIG. 2B), which is connected with the table saw assembly. In a preferred embodiment, the table saw assembly includes an arbor 306 which, in the current embodiment is a mechanical assembly that establishes the position of a saw blade 302 and operational relationship between the saw blade 302 and a motor. Thus, the arbor 306 includes the mechanical connection of the saw blade 302 and motor, thereby, establishing the position of both in relationship to the rest of the table saw assembly. The riving knife receiving mechanism 202 connects with the arbor 306, thereby establishing the riving knife receiving mechanism 202 in a fixed position relative to the saw blade. It is further understood that the arbor 306 is coupled with a work table 304 of the saw assembly and that this coupling may enable or be enabled to provide beveling and height adjustment capabilities, via the arbor 306, to the saw blade 302 relative to the work table 304. It is well known in the art to provide a bevel adjustment capability and/or a blade height adjustment capability to the saw blade 302 of a table saw assembly. Thus, the riving knife receiving mechanism 202 of the present invention may be connected with the arbor 306 in a manner which enables it to maintain its position relative to the saw blade 302 which is coupled with the arbor 306 which is capable of beveling and adjusting the height of the saw blade 302.

In a preferred embodiment, the riving knife receiving mechanism 202 is established as a first adapter and second adapter 114. In the current embodiment, the first and second adapters 114 are established as a first pin and a second pin 114 which engage with the first pin slot 110 and the second pin slot 112, respectively. It is contemplated that the first and second adapters 114 may be alternatively configured to accommodate engagement with variously configured riving knife engagement mechanism components.

The quick change riving knife assembly 100 further includes a fastening mechanism 116 which engages with the arbor 306 of the table saw assembly and the riving knife blade 102 to secure the riving knife blade 102 in position relative to the saw assembly. In a preferred embodiment, the fastening mechanism 116 is a thumbscrew assembly that includes a threaded post coupled with the arbor 306 and a thumbscrew cap 118 which screws into place on the threaded post and clamps against the riving knife blade 102, securing the position of the riving knife blade 102. The fastening mechanism 116 couples with the arbor 306 in a position which enables its component features to secure against the second end 106 of the riving knife blade 102. It is contemplated that the fastening mechanism 116 may be coupled in various positions on the saw assembly, thereby enabling its engagement in various locations on the riving knife blade 102. It is contemplated that the fastening mechanism 116 may employ a variety of devices such as a compression lock assembly, snap fit assembly, and the like, to accommodate the secure fastening of the riving knife blade.

In FIGS. 2A and 2B a second exemplary embodiment of a quick change riving knife assembly 200 includes a riving knife blade 212 with a riving engagement mechanism 214 enabled with a first keyhole 208 and a second keyhole 210. The riving knife receiving mechanism 214 is enabled with a first stud 204 and a second stud 206 which engage with the first and second keyholes 208 and 210. It is understood that the keyholes may be elongated slots and may take a variety of configurations. The fastening mechanism 216 employed with the second exemplary quick change riving knife assembly of FIGS. 2A and 2B is similar to the thumbscrew assembly shown and described in FIG. 1. It is contemplated that other suitable fastening mechanisms 216 for locking the riving knife blade 212 into position may be employed. It should be noted that it is important that the riving knife blade 212 be securely fastened to the table saw, for reasons including, but not limited to: adequately stabilizing the work piece and preventing binding of the work piece.

It is contemplated that the quick change riving knife assemblies shown and described in FIGS. 1, 2A, and 2B may provide for the engagement and release of the riving knife blade 212 with the table saw assembly by use of a quick release assembly. The quick change riving knife assemblies may include a first coupling assembly which is capable of engaging with a complimentary second coupling assembly that is mounted to the saw assembly. For instance, the riving knife blade may include a female quick coupling apparatus which may be engaged with a male quick coupling apparatus coupled with the table saw assembly. It is contemplated that the coupling assemblies may be a variety of standard and non-standard ISO configurations.

It is contemplated that various interlock assemblies may be implemented which may assist in avoiding injury to an operator when changing out the quick change riving knife assemblies. For example, an electrical interlock assembly may be coupled between the quick change riving knife assemblies and the motor which powers the saw blade of the table saw assembly. Therefore, when the operator disengages the fastening mechanism 216 or disengages the riving engagement mechanism 214 from the riving knife receiving mechanism 202, the motor may be prevented from being turned on or if the motor is running at the time the operator disengages any of these mechanisms the motor may be shut down. Further, if the operator wishes to operate the saw blade 302 without the quick change riving knife assembly coupled with the table saw assembly, then the present invention may require the operator to engage a secondary interlock assembly before the motor may operate. For instance, the operator may wish to perform a dado cut and disengage the quick change riving knife assembly which in turn prevents operation of the motor. The secondary interlock assembly may be engaged with or in a specified location in relation to the saw blade 302 which enables operation of the motor after the secondary interlock assembly is in place.

Referring now to FIG. 3, the quick change riving knife assembly 100 of FIG. 1, is shown coupled with a table saw 300. In this exemplary embodiment the quick change riving knife assembly 100 is coupled with the table saw 300 independent of the saw blade 306. The quick change riving knife assembly protrudes above the surface of a work table 304 of the table saw 300 within the same groove as the saw blade 302. Thus, as a work piece is passed through the saw blade 302 it will engage the quick change riving knife assembly 100 of the present invention.

An advantage of the present invention is that a person of normal physical strength without the use of additional hardware may operate it. A user may insert a quick change riving knife blade 102 into the table saw assembly, engage the riving engagement mechanism 108 with the riving knife receiving mechanism 202, or ISO coupling assembly as previously described, and then tighten the fastening mechanism 116, securing the quick change riving knife blade 102 to the saw assembly. Alternatively, the user may loosen the fastening mechanism 116 to release the riving knife blade 202. Thus, the user may then further disengage the riving engagement mechanism 108 from its connection with the riving knife receiving mechanism 202 enabling removal of the quick change riving knife blade 102 from the table saw assembly. Upon removal, the user may immediately replace the quick change riving knife assembly 100 with another suitable quick change riving knife assembly.

The present invention further provides a method of establishing a table saw with a riving knife 102. It is understood that the table saw may be variously configured to include many different component features. In the current embodiment, the table saw is configured, as described previously, to include an arbor 306 for coupling a saw blade 302 with a motor and further the arbor 306 is adjustably coupled with a work table 304 of the table saw. Thus, the table saw selected may be enabled with the arbor 306 which includes a riving knife receiving mechanism 202. It is contemplated that the arbor 306 may be enabled to be coupled with a riving knife receiving mechanism 202, which may enable the riving knife receiving mechanism 202 to be removed from the arbor 306 by the user.

The user may then proceed to the selection of a riving knife blade 102 which is enabled to engage with the riving knife receiving mechanism 202 established on the table saw. The selection of the riving knife blade 102 being dependent on the configuration of a riving knife engagement mechanism 108 established on a second end 106 of the riving knife blade 102. It is understood that numerous riving knife blades 102 including a variety of differently configured riving engagement mechanisms 108 may be produced and made available to the user for selection by the user. After the user has made the appropriate selection of the riving knife blade 102, based on the matching or complimentary configurations between the riving knife engagement mechanism 108 and the riving knife receiving mechanism 202, the user may proceed to couple the riving knife blade 102 with the table saw. The coupling occurs in two stages. In the first stage the user engages the riving engagement mechanism 108 with the riving knife receiving mechanism 202. In the second stage the user may secure the position of the riving knife blade 102 by engaging a fastening mechanism 116. The fastening mechanism 116 provides a fastener 118, coupled with the arbor 306, which contacts the riving knife blade 102 and securely affixes the position of the riving knife blade 102 against the arbor 306 of the table saw.

As described previously, the configurations of the various components may be changed to accommodate different needs of a manufacturer or a user. It is understood that such changes are contemplated and intended to be encompassed by the present invention.

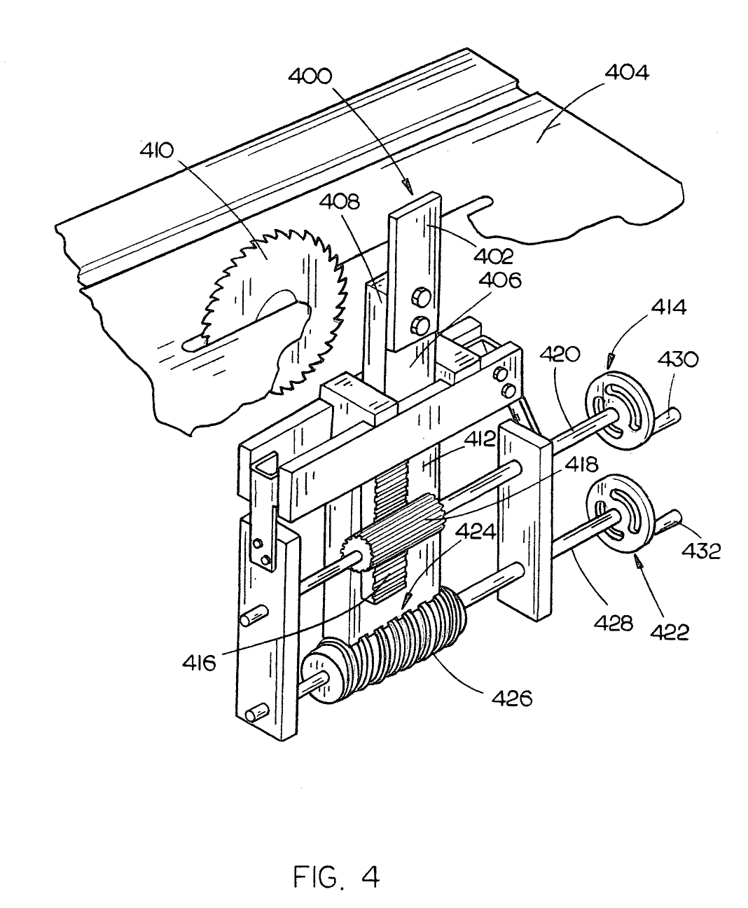

Referring now to FIG. 4, a riving knife adjustment assembly 400 is shown engaged with a table saw. In the preferred embodiment, the riving knife adjustment assembly 400 is suitable for changing the height, orientation, geometry, and the like of a riving knife blade 402 relative to a work surface 404 of the table saw, without the use of additional hand tools, and without requiring a user to come into close proximity with a saw blade. The riving knife adjustment assembly 400 includes a riving knife blade 402 coupled to a shaft member 406. In a preferred embodiment, the riving knife blade 402 connected to a first end 408 of the shaft member 406. It is understood that the shaft member 406 may be configured in a variety of forms, such as a bar, a pole, and the like. The shaft member 406 is suitable for being raised and lowered from a plane of the work surface 404 (vertical adjustment), and also suitable for being moved toward and away from a saw blade 410 in a plane of the saw blade 410 (horizontal adjustment). The shaft member 406 includes a second end 412 which is coupled with a vertical adjustment device 414 which provides the vertical movement of the shaft member 402 and riving knife blade 402 relative to the work surface 404 and saw blade 410. In the current embodiment, the vertical adjustment device 414 comprises a first rack 416 and first pinion 418. The first rack 416 is connected to a side of the shaft member 406, nearer the second end 412 of the shaft member 406. The first pinion 418 is established on a first rod 420 and engages with the first rack 416. The first pinion 418 may comprise a plurality of gears, wheels, and the like suitable for affecting the vertical adjustment of the shaft member 406 with respect to the work surface 404 and saw blade 410.

A horizontal adjustment device 422 provides the horizontal movement of the shaft 406 and riving knife blade 402 relative to the work surface 404 and saw blade 410. In the current embodiment, the horizontal adjustment device 422 comprises a second rack 424 and a second pinion 426. The second rack 424 is connected to an edge of the shaft member 406, the edge substantially defining a terminal portion of the second end 412 of the shaft member 406. The second pinion 426 is established on a second rod 428 and engages with the second rack 424. The second pinion 426 may comprise a plurality of gears, wheels, and the like suitable for affecting the horizontal adjustment of the shaft member 406 with respect to the work surface 404 and saw blade 410.

The plurality of gears, wheels, and the like may be connected to cranks, levers, and the like suitable for affecting the rotational position of the gears, wheels, and the like, and consequently the vertical and horizontal adjustment of the shaft member 406 and the riving knife blade 402. It should be noted that the riving knife blade 402 and the shaft member 406, the plurality of gears, wheels, and the like, and the plurality of cranks, levers, and the like, may be of one piece construction without departing from the scope and spirit of the present invention.

A user may determine the necessary height of the riving knife blade 402 and grasp a first crank 430 connected with the first rod 420, rotating the first crank 430 in a clockwise and counterclockwise direction to alternately raise and lower a riving knife adjustment assembly 400. The user may also determine the necessary distance of the riving knife blade 402 from the saw blade 410 and grasp a second crank 432 connected with the second rod 428, rotating the second crank 432 in a clockwise and counterclockwise direction to alternately move the riving knife adjustment assembly 400 toward and away from the saw blade. It should be appreciated by one of ordinary skill in the art that the position, orientation, geometry, and the like of the gears, wheels, and the like may determine the effect of clockwise and counterclockwise rotation of the first and second cranks 430 and 432.

In a first orientation of gears, wheels, and the like, clockwise rotation of the first crank 430 may raise the riving knife blade 402, while in a second orientation, counterclockwise rotation may raise the riving knife blade 402. Conversely, in a first orientation of gears, wheels, and the like, counterclockwise rotation of the first crank 430 may lower the riving knife blade 402, while in a second orientation, clockwise rotation may lower the riving knife blade 402. It should be noted that this principle would also apply to adjustment of the horizontal position of the riving knife blade 402. In a first orientation of the gears, wheels, and the like, clockwise rotation of the second crank 432 may move the riving knife blade 402 toward the saw blade 410, while in a second orientation, counterclockwise rotation may move the riving knife blade 402 toward the saw blade 410. Conversely, in a first orientation of gears, wheels, and the like, counterclockwise rotation of the second crank 432 may move the riving knife blade 402 away from the saw blade 410, while in a second orientation, clockwise rotation may move the riving knife blade 402 away from the saw blade 410.

Alternatively, the riving knife adjustment assembly 400 may include a powered adjustment assembly. The powered adjustment assembly may operate using hydraulic systems or pneumatic systems. A selector assembly may be coupled to the hydraulic or pneumatic system and mounted upon a saw assembly in a position for easy use by an operator. The selector assembly may determine the operation of the powered adjustment assembly. Alternatively, a computing system may be employed to communicate the commands of an operator to the powered adjustment assembly. The computing system may be mounted to a saw assembly to which the powered adjustment assembly is coupled or the computing system may be remotely located to the saw assembly and maintain communicative coupling. The communicative coupling may occur via radio frequency, infrared, and the like. Further, the computing system may be in communication with other computing systems and provide access to the saw assembly via those other computing systems. In addition, the computing system may determine an optimal position for user safety and adjust the position of the riving knife accordingly.

The computing system may be enabled to store multiple programs for performing multiple tasks with the saw assembly. For instance, the computing system may be enabled to store and perform a first through cut and then a second dado cut. Alternatively, the computing system may be enabled to store a particular cut and repeat the cut on command. Additionally, the computing system may enable the saw assembly to execute a series of cut programs downloaded from an external source into the computing system.

A method of adjusting a riving knife 402 of a table saw is provided by the present invention. The method includes establishing the table saw with a riving knife adjustment assembly 400. The riving knife adjustment assembly 400 providing a vertical adjustment device 414 and a horizontal adjustment device 422 which may be operationally coupled with the riving knife 402. A user determines the desired vertical position of the riving knife 402 and engages with the vertical adjustment device 414 to set this particular orientation. The user may then determine a desired horizontal position of the riving knife 402 and engage with the horizontal adjustment device 422 to set this particular orientation. It is understood that the order in which the vertical or horizontal orientation is determined or set may be changed without departing from the scope and spirit of the present invention. It is further contemplated that after the vertical and horizontal orientations are set the user may operate the table saw with the riving knife 402 in the desired position.

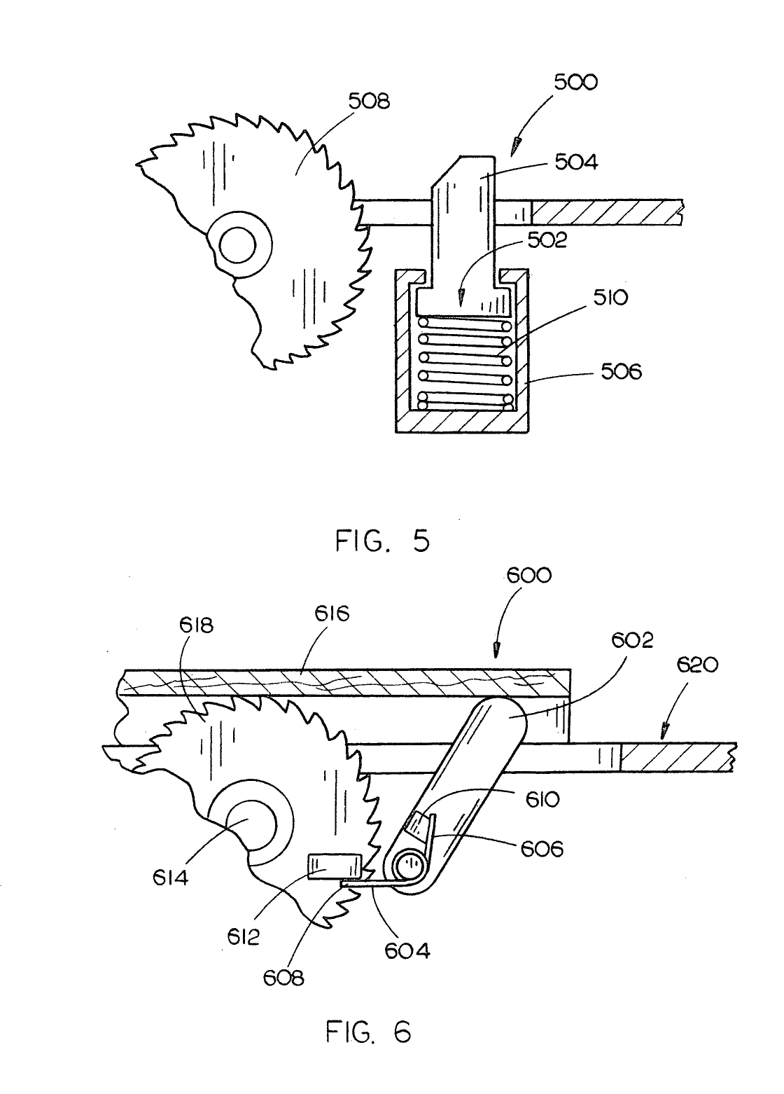

Two exemplary embodiments of a biasing riving knife assembly 500 and 600 are shown in FIGS. 5 and 6. In FIG. 5 the biasing riving knife assembly 500 includes a compression spring assembly 502 coupled to a riving knife blade 504, which enables the riving knife blade 504 to move vertically up and down. The compression spring assembly 502 includes a compression spring 510 disposed within a housing 506 that may be configured to contain a part of the riving knife blade 504 or may simply house the compression spring 510. The vertical movement enables the biasing riving knife assembly 500 to be used with a table saw assembly performing a variety of cuts, such as through cuts, dado cuts, and the like. The biasing riving knife assembly 500 automatically changes the height, orientation, geometry, and the like of the riving knife blade 504 without additional user intervention, such change being suitable and appropriate for the height, orientation, geometry, and the like of a work piece being fed into or across a saw blade 508 of the table saw assembly.

The biasing riving knife assembly 500 may include a riving knife blade 504 with a substantially beveled leading edge suitable for being displaced by a work piece. It is understood that other configurations for the leading edge of the riving knife blade 504 may be employed without departing from the scope and spirit of the present invention. In the exemplary embodiment of the present invention, the compression spring 510 is sufficiently strong to force the riving knife blade 504 into the kerf of the work piece provided the riving knife blade 504 is sized appropriately for the kerf. It should be noted that the spring biasing means could be replaced with a sensing and positional adjustment means including a sensor and a motor, a material capable of substantial deflection, and the like, without departing from the scope and spirit of the present invention.

Referring now to FIG. 6, a biasing riving knife assembly 600 coupled with a table saw assembly, is shown. A riving knife blade 602 is rotationally connected to the table saw assembly via a spring member 604. In the preferred embodiment, the spring member 604 is a leaf spring including a first end 606 and a second end 608. The first end 606 of the leaf spring couples with the riving knife blade 602 through a connection with a first mount member 610 connected to the riving knife blade 602. The second end 608 of the leaf spring couples with the table saw assembly. In a preferred embodiment, the second end 608 may connect with a second mount member 612 which is connected to an arbor 614 of the table saw assembly. In the case of a user making a dado cut, necessitating a riving knife blade 602 with a comparatively low profile, as a work piece 616 travels past a saw blade 618, the leading edge of the work piece 616 contacts a substantially beveled leading edge of the riving knife blade 602, biasing the riving knife assembly 600 away from the saw blade 618 and downward, in a direction below the plane of a tabletop work surface of the table saw assembly. The force of the spring member 604, however, is sufficient to keep a portion of the riving knife blade 602 substantially engaged with the kerf of the work piece. It should be noted that the force of the spring 604 should also be sufficient to keep the riving knife blade 602 substantially vertical with respect to the table top 620 when making a through cut.

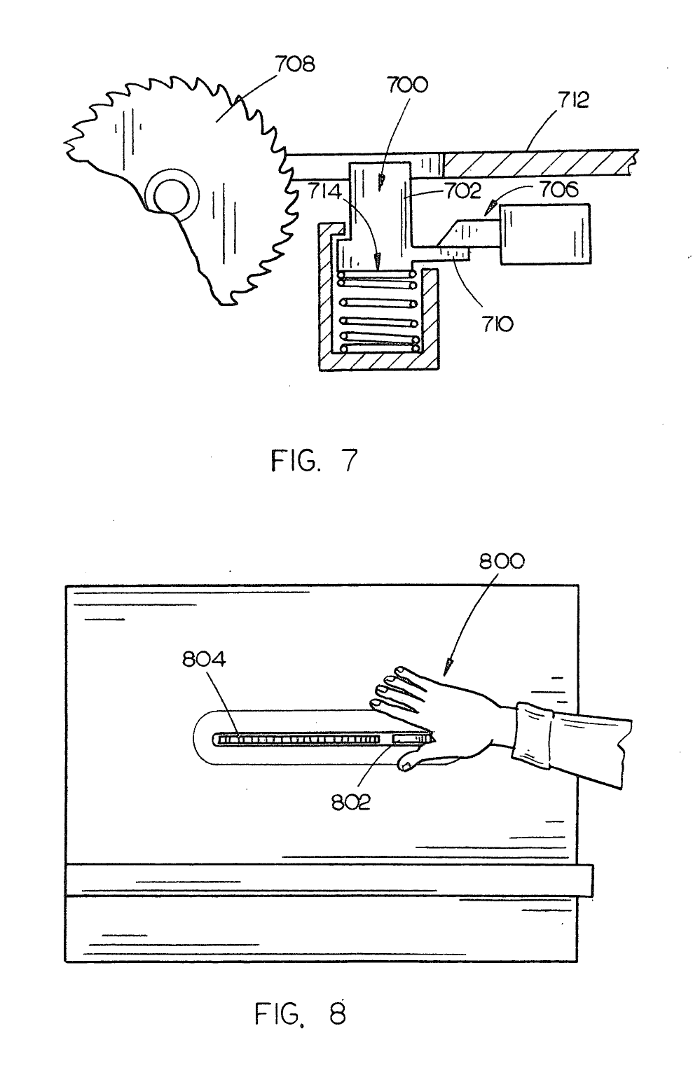

A third exemplary embodiment of a biasing “pop-up” riving knife assembly 700 is shown in FIG. 7. The pop-up riving knife assembly 700 is coupled with a table saw assembly and includes a riving knife blade 702 coupled with a spring assembly 704 and a stop assembly 706. The riving knife blade 702 is capable of automatic deployment to a “safe” position at the conclusion of a cut requiring the lowering or removal of the riving knife blade 702. The “safe” position being an extended position which may also offer additional safety to users of the table saw assembly as it may prevent contact by the user with a saw blade 708 of the table saw assembly. The automatic deployment of the riving knife blade 702 is enabled by the spring assembly 704 and the stop assembly 706. The riving knife blade 702 includes an armature 710, which extends away from the riving knife blade 702 and may be engaged with the stop assembly 706. Thus, when the riving knife blade 702 is not to be used the armature 710 engages with the stop assembly 706 and is prevented from extending above a work surface 712 of the table saw assembly. However, when the riving knife blade 702 is to be used, the stop assembly 706 disengages the armature 710 and the spring assembly 704 forces the riving knife blade 702 up through a slot in the work surface 712.

The stop assembly 706 may include a contact button or switch, connected to a lever assembly, capable of raising the riving knife blade substantially above a plane of the work surface 712 of the table saw assembly upon removal of a work piece. Alternately, the stop assembly 706 may include a latch coupled to an electric motor, such as an electric motor of the table saw assembly which engages the saw blade 708, capable of releasing the riving knife blade 702 from a lowered position to a position substantially above the plane of the work surface 712 upon cessation of electric current to the electric motor engaging the saw blade 708. Alternatively, the stop assembly 706 may include a computing system which enables its operation from either the table saw assembly or a remote location. The computing system may be enabled with similar features and functionality as that described above in FIG. 4.

Upon completion of the sawing of a work piece requiring a substantially lowered riving knife assembly, the pop-up riving knife assembly 700 would pop-up to the “safe” position. For instance, a user may have lowered the riving knife blade 702 to make a dado cut. This pop-up feature may have the advantage of not only convenience for users who may more commonly make through cuts and only rarely make dado cuts, but it may also increase the life-span of saw blades 708 used with the table saw assembly, as the pop-up riving knife assembly 700 would reduce the amount of wear on the saw blades 708. In addition, the pop-up riving knife assembly 700 may serve to increase the overall operational safety of the table saw or other saw assemblies to which it is coupled, keeping a user from being able to contact the rear of the saw blade 708 when the pop-up riving knife assembly 700 is in the “safe” position.

FIG. 8 of the present invention is directed to a fourth exemplary embodiment of a biasing “position” riving knife assembly 800. The position riving knife assembly 800 includes a riving knife blade 802 for a table saw assembly positioned substantially behind a saw blade 804 of the table saw assembly. In the exemplary embodiment, the distance the riving knife blade 802 is located behind the saw blade 804 may be substantially increased to limit the chance of a user contacting the saw blade 804 from behind. It should be noted that if a blade guard is attached to the riving knife blade 802, this positional location would have the added benefit of increasing the footprint of the blade guard, making it more difficult for a user to bypass the blade guard and contact the saw blade 804.

In a still further embodiment of the present invention, a method of establishing a table saw with a biasing “pop-up” riving knife assembly 700 is provided. In a first step a user determines the type of cuts they wish to perform with the table saw. Once the type of cut is determined, the user selects a coupling mechanism for enabling a biasing element which will further enable the type of cut to be performed using the table saw. The user may then select the riving knife blade 708 they wish to employ. The user may determine that the riving knife blade 708 requires a particular type of leading edge or a particular ability to be coupled with the biasing element. The user then couples the selected riving knife blade 708 with the biasing element. The user performs the desired cutting operation upon a work piece, wherein the riving knife blade 708 engages with the work piece in a desired manner as determined by the selection of the coupling mechanism and biasing element. It is understood that various changes may be made in the order of the steps performed and selection and configuration of components to establish the biasing “pop-up” riving knife assembly 700 upon the table saw without departing from the scope and spirit of the present invention.

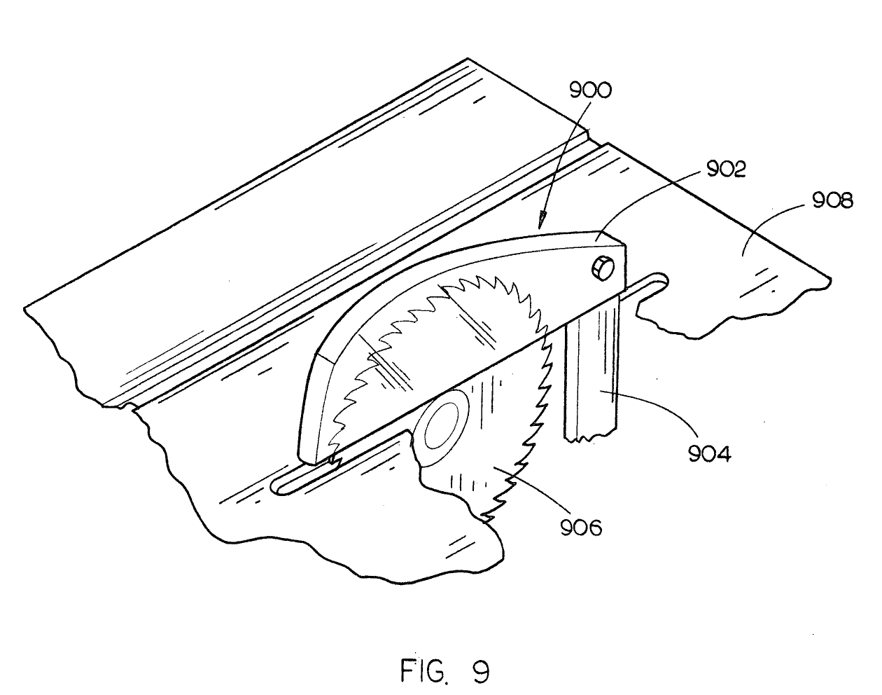

Referring now to FIG. 9, a riving knife integrated blade guard assembly 900 is shown. In a preferred embodiment, the blade guard 902 is integral with the riving knife blade 904. Thus, the riving knife integrated blade guard assembly 900 is coupled with a table saw assembly. Blade guards 902 are well known to the prior art, but many blade guards 902 are large and cumbersome. Therefore, the riving knife integrated blade guard assembly 900 of the present invention provides a blade guard 902 having a smaller profile with respect to the width of a saw blade 906, being easily lifted off of a worktable 908 by a work piece when cutting, while still affording protection to a user in the plane of the saw blade 906. In the exemplary embodiment of the present invention, the riving knife integrated blade guard assembly 900 includes a blade guard 902 with a lateral dimension with respect to a saw blade 906 only substantially slightly greater than the overall width of the saw blade 906, while completely enclosing the saw blade 906 when resting against a worktable 908. The riving knife integrated blade guard assembly 900 may include a riving knife blade 904 rotationally connected to the blade guard 902, the riving knife blade 904 and blade guard 902 being substantially rigid and suitable for remaining parallel to a plane of the saw blade 906. Further, it is contemplated that the blade guard 902 may be enabled to be removed from the riving knife blade 904. Various fasteners, fastening systems, latch systems, and the like may be employed to accommodate this desired functionality. The riving knife blade 904 and blade guard 902 may be composed of plastic, metal, composite material, and the like, as contemplated by one of ordinary skill in the art.

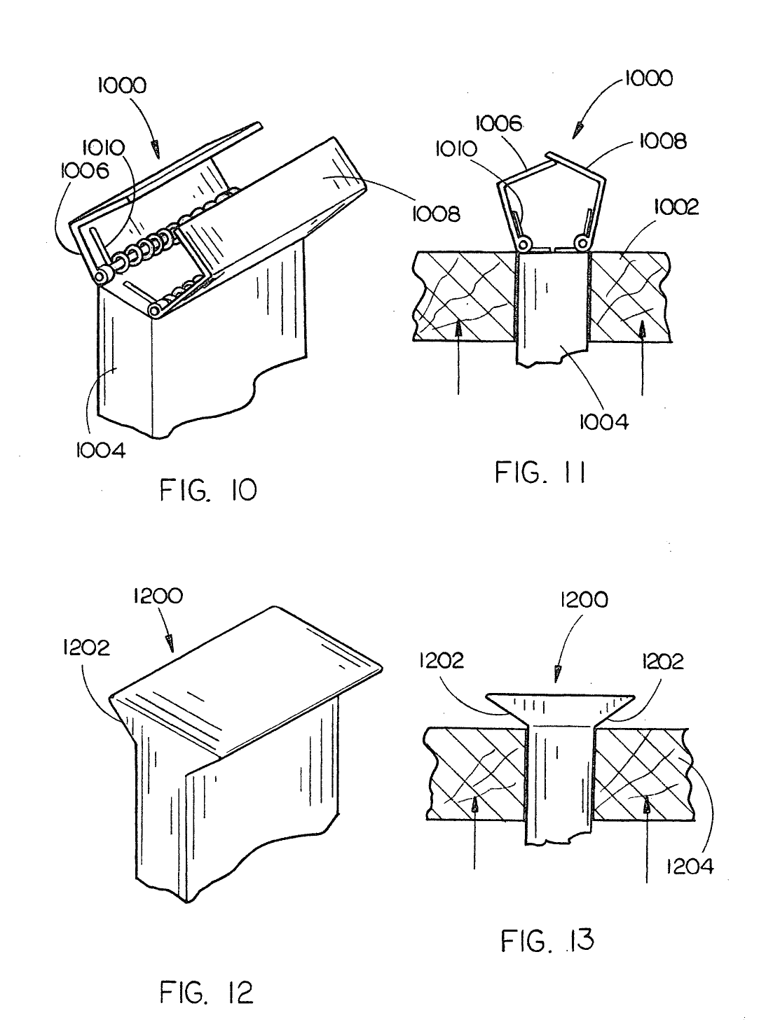

FIGS. 10 and 11 show a riving knife spring tab mechanism 1000. The riving knife spring tab mechanism 1000 is coupled with a table saw assembly and is suitable for keeping a work piece 1002 engaged against a tabletop of the table saw assembly while cutting the work piece 1002. In FIG. 10 the riving knife spring tab mechanism 1000 includes a riving knife blade 1004, a first right-angled tab 1006 rotationally connected to the riving knife blade 1004, and a second right-angled tab 1008 rotationally connected to the riving knife blade 1004. Both the first and second right-angled tabs 1006 and 1008 include a contoured guidance member that engages with a spring 1010 or a leaf spring. If a work piece 1002 has a propensity to be pushed out of the plane of the worktable, or “kick up,” during operation of the table saw, the interference between the first and second right-angled tab assemblies 1006 and 1008 serves to force the work piece 1002 back against the tabletop.

As shown in FIG. 11 the riving knife spring tab mechanism 1000 is engaged with a work piece 1002 which is trying to “kick up” as indicated by the arrows. The first and second tabs 1006 and 1008 extend out over the work piece 1002 at various degrees. The degree of extension may be determined and set by the manufacturer or consumer in order to meet specific needs. If the engagement of the work piece 1002 with one or both of the tabs 1006 and 1008 is moderate, then the tabs 1006 and 1008 apply a moderate degree of resistance. As the severity of the “kick up” increases so does the resistance provided by the tabs 1006 and 1008. At it most severe the tabs 1006 and 1008 engage one another and prevent further movement on either side, thus, the range of movement the work piece 1002 experiences is limited.

It is contemplated that the size and shape of the tabs 1006 and 1008 may vary. Further, the tension in the spring 1010 or leaf spring may vary to accommodate specific design needs. It is understood that the spring 1010 or leaf spring may be a variety of designs without departing from the scope and spirit of the present invention.

Referring now to FIGS. 12 and 13, a riving knife wedge flange assembly 1200 is shown. The riving knife wedge flange assembly 1200 provides a one piece assembly designed to assist saw assembly operators with avoiding “kick up”. The one piece design provides enhanced rigidity to a wedge flange 1202 for resisting work piece “kick up”. As shown in FIG. 13, a work piece which is engaged with the riving knife wedge flange assembly 1200 is forced against the wedge flange 1202 during a “kick up” and is thereby prevented from significant movement. As with FIGS. 10 and 11, this riving knife wedge flange assembly 1200 design is to prevent movement of the work piece 1204 while still engaged with a saw. This is important as it may assist in avoiding damage to the work piece as it is being operated upon by the saw. Further, it may assist in avoiding harm to an operator of the saw. When working with large work pieces and large saw blades the amount of “kick up” may be quite severe and such an event may cause serious injury resulting in lost work time and compensation costs.

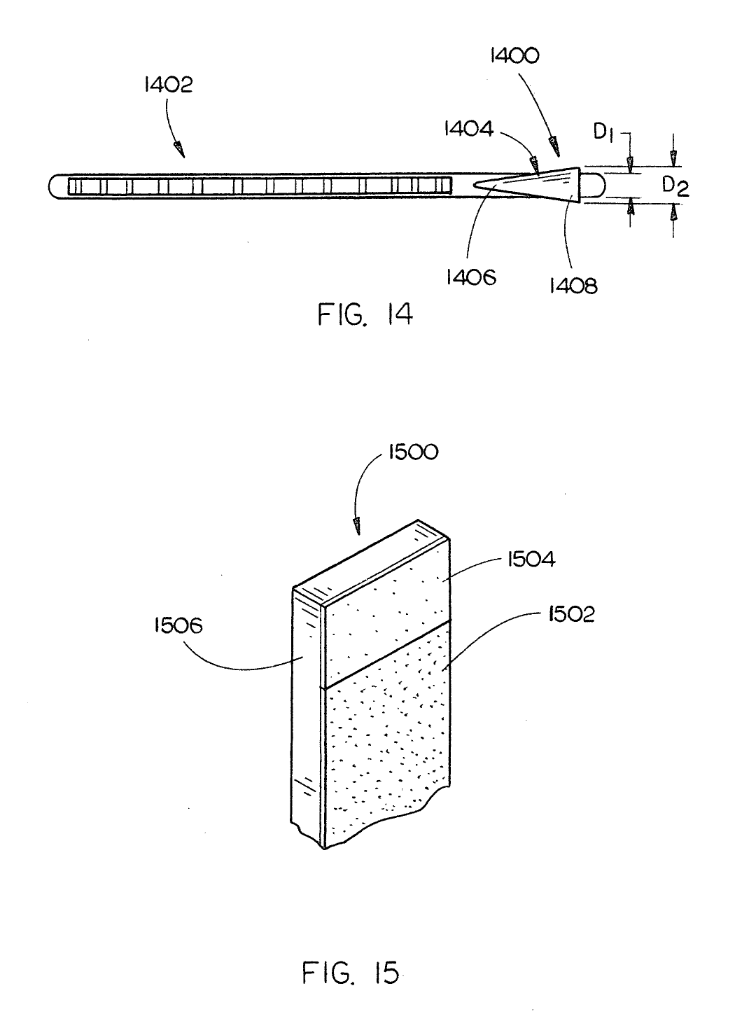

A riving knife profile assembly 1400 is shown in FIG. 14. The riving knife profile assembly 1400 provides a profile riving knife blade 1404 with increasing thickness in a direction parallel to a plane of a saw blade 1402 for a saw assembly, such as a table saw. The profile riving knife blade 1404 includes a first and second portion 1406 and 1408, the first portion 1406 being the leading edge which is substantially adjacent to the saw blade 1402. The second portion 1408 is the trailing edge and is substantially thicker than the first portion 1406. As a work piece is fed into or across the saw blade 1402, a user might find it desirable to spread the slot of the work piece created by the cutting action of the saw blade 1402 farther apart than the width of the kerf. In the exemplary embodiment, the first portion 1406 of the profile riving knife blade 1404 would enter the slot created by the saw blade 1402, and the second portion 1408, behind the first portion with respect to the saw blade 1402, would spread the kerf substantially farther apart than the width of the saw blade 1402. The spreading of the kerf may serve to lengthen the life of the saw blade 1402, as well as to prevent excessive binding of the work piece as the saw blade 1402 cuts it.

Additionally, a wider trailing edge of the profile riving knife blade 1404 may serve to better enable the attachment of a wide variety of devices. For example, a blade guard may be more easily mounted on the wider trailing edge of the profile riving knife blade. Further, a guidance assembly may be mounted to the trailing edge providing an assembly for preventing “kick up” of the work piece as it is being fed through the saw blade. Still further, a wider trailing edge may provide additional protective capabilities by having a larger surface to which an operator's hand may engage, thus preventing casual contact with the saw blade 1402.

Referring now to FIG. 15, a friction riving knife assembly 1500 is shown. In a preferred embodiment, the friction riving knife assembly 1500 includes a first section 1502 and a second section 1504. The first section 1502 includes a low friction coating. The low friction coating is disposed on the first section which abuts a work surface, such as a tabletop of a table saw assembly, of a saw assembly. The second section 1504 includes a high friction coating. The high friction coating is disposed on the second section 1504 of the riving knife blade 1506, the second section 1504 of the riving knife blade 1506 being adjacent to the first section 1502 and above the plane of the work surface of the saw assembly. The low friction coating allows a work piece being operated upon by a saw assembly to slide by, thus maintaining the movement of the work piece. This is critical for performance of the saw assembly and life of the saw assembly. If the friction coating creates too much drag on the work piece as it goes by, a saw blade of the saw assembly will be required to work too hard and its useful life will be severely diminished.

The high friction coating is suitable for keeping a work piece engaged against a tabletop of a table saw assembly while cutting the work piece. The high friction coating acts as an impediment to “kick up” by a work piece being operated upon by a saw of the saw assembly. If a work piece has a propensity to be pushed out of the plane of the worktable, or “kick up,” during operation of the table saw, the interference between the work piece and the high friction coating serves to force the work piece back against the tabletop. It should also be noted that the friction riving knife assembly 1500 may include only the low friction coating, only the high friction coating, or the high friction coating may consist of ridges, abrasions, and the like, without departing from the scope and spirit of the present invention.

It is understood that the various riving knife assemblies and features which may be enabled upon riving knife blades may be configured in various combinations as contemplated by those of ordinary skill in the art. For instance, the spring tab mechanism, wedge flange, friction coatings, may all be enabled upon one of the various embodiments of the quick change riving knife assembly and biasing riving knife assembly. Further, the riving knife adjustment assembly may enable the quick change riving knife assembly as well as a riving knife blade enabled with the spring tab mechanism, wedge flange, and/or friction coatings.

It is contemplated that the present invention provides a method for establishing a table saw which may be enabled to assist in avoiding “kick up” by a work piece being cut by the table saw. Further, a method for establishing a table saw which may be enabled to assist in providing additional avoidance mechanisms for contributing to user safety, may be contemplated by the present invention. Still further, a table saw which may assist in promoting kerf expansion in a work piece being cut by the table saw is contemplated by the present invention.

It is understood that the specific order or hierarchy of steps in the methods disclosed are examples of exemplary approaches. Based upon design preferences, it is understood that the specific order or hierarchy of steps in the method can be rearranged while remaining within the scope and spirit of the present invention. Further, the exemplary methods disclosed may be implemented as sets of instructions or software readable by a device, such as the computer system disclosed in FIG. 4. The accompanying method claims present elements of the various steps in a sample order, and are not necessarily meant to be limited to the specific order or hierarchy presented.

It is believed that the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A quick change riving knife, for use with a saw assembly including a frame for at least partially encompassing and connecting with a motor for driving a saw blade and further connecting to the frame a substantially planar work surface including a slot through which the saw blade at least partially extends during operation of the saw blade, comprising:
a riving knife blade generally oriented in relation to the saw blade, the riving knife blade having a first end for substantially extending through the slot and above the planar work surface of the saw assembly and a second end including a riving engagement mechanism;
a riving knife receiving mechanism connected to the saw assembly, the riving knife receiving mechanism for engaging the riving engagement mechanism of the second end of the riving knife blade; and
a fastening mechanism connected to the saw assembly, the fastening mechanism for adjustably contacting the second end of the riving knife blade,
wherein the quick change riving knife enables the engagement and release of the riving knife blade to and from the saw assembly.

2. The quick change riving knife of claim 1, further including a blade guard.

3. The quick change riving knife of claim 1, further including a spring tab mechanism.

4. The quick change riving knife of claim 1, wherein the first end of the riving knife blade includes a wedge flange.

5. The quick change riving knife of claim 1, wherein the riving knife blade is a profile riving knife blade.

6. The quick change riving knife of claim 1, wherein the riving knife blade is a friction riving knife blade.

7. A riving knife adjustment assembly, for use with a saw assembly including a riving knife and a frame for at least partially encompassing and connecting with a motor for driving a saw blade and further connecting to the frame a substantially planar work surface including a slot through which the saw blade at least partially extends during operation of the saw blade, comprising:
a shaft member having a first end connected with the riving knife blade and a second end;
a vertical adjustment device operationally engaging the second end of the shaft member, the vertical adjustment device enabling a user to establish a vertical orientation of the riving knife blade relative to the planar work surface;
a horizontal adjustment device operationally engaging the second end of the shaft member, the horizontal adjustment device enabling the user to establish a horizontal orientation of the riving knife blade relative to the saw blade,
wherein the riving knife adjustment assembly allows the user to selectively determine the position of the riving knife blade relative to the saw assembly.

8. The riving knife adjustment assembly of claim 7, including a quick change riving knife blade.

9. The riving knife adjustment assembly of claim 7, including a blade guard.

10. The riving knife adjustment assembly of claim 7, including a spring tab mechanism.

11. The riving knife adjustment assembly of claim 7, including a wedge flange.

12. The riving knife adjustment assembly of claim, includes a profile riving knife blade.

13. The riving knife adjustment assembly of claim 7, including a friction riving knife blade.

14. A biasing riving knife assembly including a riving knife blade, for use with a saw assembly including a frame for at least partially encompassing and connecting with a motor for driving a saw blade and further connecting to the frame a substantially planar work surface for receiving a work piece, the substantially planar work surface including a slot through which the saw blade at least partially extends to perform a cutting function upon the work piece, comprising:
a coupling mechanism connected with the saw assembly, the coupling mechanism for establishing the riving knife blade upon the saw assembly;
a biasing element including a first end connected to the riving knife blade and a second end connected with the coupling element,
wherein the biasing element provides a force sufficient to keep a portion of the riving knife blade in a kerf of the work piece as it is being cut by the saw blade.

15. The biasing riving knife assembly of claim 14, including a blade guard.

16. The biasing riving knife assembly of claim 14, including a spring tab mechanism.

17. The biasing riving knife assembly of claim 14, including a wedge flange.

18. The biasing riving knife assembly of claim 14, including a profile riving knife blade.

19. The biasing riving knife assembly of claim 14, including a friction riving knife blade.

20. The biasing riving knife assembly of claim 14, further including a riving knife adjustment assembly.

21. The biasing riving knife assembly of claim 14, further including a stop assembly.

22. A table saw assembly, comprising:
an arbor operationally coupling a motor with a saw blade, the arbor being adjustably coupled with an underside of a work surface including a slot extending from the underside to a top side of the work surface, the adjustable coupling of the arbor with the work surface enabling the arbor to extend at least a portion of the saw blade through the slot and above the top side of the work surface and further enable a beveling and blade height adjusting capability of the saw blade relative to the work surface;
a riving knife receiving mechanism coupled with the arbor in a manner enabling the riving knife receiving mechanism to operationally maintain its position relative to the arbor while the arbor is enabling the beveling and blade height adjustment of the saw blade, the riving knife receiving mechanism including a first adapter and a second adapter;
a riving knife blade including a first end and a second end, the first end for at least partially extending through the slot above the top side of the work surface in a position behind the saw blade, the second end further including a first receiver and a second receiver, the riving knife blade for coupling with the riving knife receiving mechanism through engagement of the first adapter with the first receiver and the second adapter with the second receiver; and
a fastening mechanism including a fastener coupled with the arbor in a position which enables the fastener to secure the position of the riving knife blade when the riving knife blade is coupled with the riving knife receiving mechanism,
wherein the riving knife blade is enabled with a quick change capability by being inserted into and removed from the riving knife receiving mechanism of the table saw assembly.

23. The table saw assembly of claim 22, wherein the riving knife receiving mechanism includes a generally U-shaped sleeve disposed with a first post and a second post.

24. The table saw assembly of claim 22, wherein the first and second receivers are angled slots.
